(19) United States
(12) Patent Application Publication
(10) Pub. No.: US 2011/0014373 A1
(43) Pub. Date: Jan. 20, 2011

(54) Foodware Decorating System and Method

(75) Inventor: Alison Perry, Wilton, CT (US)

Correspondence Address: MCCARTER & ENGLISH, LLP STAMFORD, CANTERBURY GREEN, 201 BROAD STREET, 9TH FLOOR, STAMFORD, CT, 06901, US

(73) Assignees: Alison Perry, Wilton, CT (US); Christopher Perry, Wilton, CT (US)

(21) Appl. No.: 12/502,397

(22) Filed: Jul. 14, 2009

(51) Int. Cl. B05C 1/00; B05D 5/00

(52) U.S. Cl. 427/256; 118/200

(57) ABSTRACT

The present disclosure provides advantageous decorating systems for use with foodware, i.e., food and beverage-related items, such as platters, glasses, trays and the like. The present disclosure further provides decorating methods that may be employed to decorate and/or customize foodware. The disclosed systems and methods generally involve application of a priming material (e.g., an egg white-based material) to a desired region of a foodware surface, and then application of a decorative/customization material to the primed surface. The decorative/customization material is stable during use, but may be washed (with the priming material) from the foodware surface using conventional washing techniques.

### BACKGROUND

1. Technical Field

The present disclosure is directed to advantageous decorating systems for use with foodware, i.e., food and beverage-related items, such as platters, glasses, trays and the like. The present disclosure is further directed to decorating methods that may be employed to decorate and/or customize foodware.

2. Background Art

People like to entertain and to be entertained. Due to financial and practical constraints, consumers are generally not inclined to purchase or rent foodware for each specific occasion or circumstance. Thus, for example, individuals involved in hosting gatherings for particular occasions/celebrations or theme-based events may desire that their foodware, e.g., platters, glasses, trays, etc., fit with and/or augment the specific occasion/celebration/theme. However, practical considerations—such as cost, time constraints, storage concerns for product inventory and general wastefulness—may inhibit or discourage such individuals from acquiring foodware that is specially suited to a particular hosted event.

Efforts have been made to permit homemakers, caterers and/or restaurant personnel to customize food products to enhance particular occasions, celebrations or theme-based events. Thus, it is common for cakes to be decorated with edible products in the form of written messages, decorative features and/or reproduced photographs. Examples of products and techniques for decorating foods are found in the patent literature and in commercial offerings. See, e.g., U.S. Pat. No. 6,432,461 to Dixon (“Edible Cake Decorations”); U.S. Pat. No. 3,961,082 to Winkler (“Edible Food Casing Printed with Water-Resistant Ink”); U.S. Pat. No. 4,578,273 to Krubert (“Printing of Foods”); U.S. Pat. No. 6,242,026 to Feeley (“Illustration Applicator for Food Products”); U.S. Pat. No. 6,432,462 to Brissonneau (“Printed Decorations for Pastry”); U.S. Pat. No. 6,506,425 to Gustafsson (“Packaged Markable Ingestible Compressible Object”); U.S. Pat. No. 5,144,880 to Schmit (“Food Decorating Device and Method”); U.S. Pat. No. 4,844,917 to DeLorimiere (“Cake Frosting Assembly”); U.S. Pat. No. 3,852,494 to Williamson (“Methods and Apparatus for Decorating Confectionary Items”); U.S. Pat. No. 6,887,504 to Palmer et al. (“Marking Pen for Decorating Food”); U.S. Pat. Nos. 6,990,892 and 7,331,776 to Errera (“Food Embossing Stamper Device”); www.cakeworkscentral.com (edible decorating paints).

Despite efforts to date, a need remains for systems and methods that permit individuals to efficiently customize foodware, e.g., food and beverage-related items, such as platters, glasses, trays and the like, on an as-desired basis. In addition, a need remains for systems and methods that allow individuals, e.g., homemakers, caterers, restaurant personnel, etc., to achieve or implement a desired foodware decoration and/or customization that is safe, stable during use, and easily cleaned/removed after use. These and other needs are satisfied by the systems and methods disclosed herein.

### SUMMARY

According to the present disclosure, advantageous systems and methods for decoration and/or customization of foodware, e.g., food and beverage-related items, such as platters, glasses, trays and the like, are provided. The disclosed systems and methods permit individuals, e.g., homemakers, caterers and restaurant personnel, to decorate and/or customize foodware in a safe, efficient and cost effective manner. Moreover, the disclosed systems and methods may be used to create decorated and/or customized foodware that is stable during use, but is easily cleaned after use to remove such decoration/customization, thereby permitting reuse of the underlying foodware on future occasions with different (or without) customization/decoration.

Typically, the decorating tool(s) contain a liquid or viscous material that may be safely and efficiently applied to foodware. The material is generally edible, washable, colored and optionally flavored. A priming material is first applied to a foodware surface in the region to be decorated/customized, e.g., using an applicator tool, brush or the like.

Once the foodware surface is “primed” in desired region(s), an applicator containing a desired color material and with a desired applicator tip shape may be used to apply desired decoration/customization to the primed surface of the foodware. Typically, it is desirable to allow the customizing/decorating material to dry before use with food and/or drink.

The disclosed system/method may be used to create essentially any design or visual effect on the surface of foodware, e.g., to make everyday dishes/glasses more festive or appropriate for particular events/occasions. Once the foodware has been used, i.e., the event/meal is concluded, the customized/decorated foodware may be easily cleaned for reuse, e.g., by washing the foodware in the normal way (e.g., in a dishwasher).

The disclosed system and method offers substantial advantages relative to prior art systems and techniques. For example, the disclosed decorations/customization are not permanent. In addition, unlike other products that are currently available, the disclosed decorating/customizing technique does not take long to apply and does not need to be baked in the oven to set. Still further, the customization/decoration is stable during use, but easily and efficiently removed (through conventional washing steps) after use. Thus, significant efficiencies are achieved according to the present disclosure.

Additional features, functions and advantages associated with the disclosed system and method will be apparent from the detailed description which follows, particularly when read in conjunction with the appended figures.

### BRIEF DESCRIPTION OF THE FIGURES

To assist those of ordinary skill in the art in implementing and using the systems and methods of the present disclosure, reference is made to the accompanying figures, wherein:

FIGS. 1 and 2 are schematic views of exemplary applicator tools according to the present disclosure;

FIG. 3 is an exploded view of an exemplary priming applicator with priming cartridge being introduced thereto;

FIGS. 4 and 5 are exemplary applicator tips of various designs;

FIGS. 6-8 are exemplary foodware samples that are decorated/customized according to the present disclosure.

### DESCRIPTION OF EXEMPLARY EMBODIMENT(S)

As described herein, the disclosed systems and methods facilitate decoration and/or customization of foodware, e.g., food and beverage-related items, such as platters, glasses, trays and the like, in a safe, efficient and cost effective manner. Foodware decorated and/or customized according to the present disclosure is stable during use, but is easily cleaned after use to remove such decoration/customization, thereby permitting reuse of the underlying foodware on future occasions with different (or without) customization/decoration.

According to exemplary embodiments of the present disclosure, decorating tool(s) are provided for use by an individual in decorating desired foodware, e.g., platters, glasses, trays, etc. The decorating tool(s) would advantageously allow anyone to custom decorate their own platters, glasses, trays, etc., in order to make them more festive, to label food items and their ingredients, or for any other purpose that may identified by such individual.

Typically, the decorating tool(s) contain a liquid or viscous material that may be safely and efficiently applied to foodware. The material is generally edible, washable, colored and optionally flavored. After initial ‘priming’ of the surface to be decorated/customized (as discussed herein), the applied material would be delivered using the decorating tool(s) and would advantageously dry in a relatively short period, e.g., within 60 seconds. The decorating tool(s) may be adapted to interact with one or more applicator tips. Thus, in exemplary implementations of the present disclosure, the applicator tool may be configured to detachably engage (e.g., through a threading arrangement) with a variety of applicator tips that define different shapes/designs for delivery of the liquid/viscous material to the foodware surface. In further exemplary implementations, the applicator tips may be fabricated, at least in part, with a firm yet pliable sponge-like material to facilitate interaction with the foodware surface to be decorated/customized.

In use, the foodware surface would first be primed to ensure that the decorating material effectively “bonds” to the foodware surface. In exemplary implementations of the present disclosure, the priming material comprises an egg wash glaze (prepared from egg whites) that is typically clear (or substantially clear) in appearance. Alternatively, a meringue powder may be used to prepare an appropriate priming material, e.g., meringue powder formulated using, inter alia, corn starch and egg whites. An exemplary meringue powder for use in preparing a priming material according to the present disclosure is available from Wilton Industries, Inc. (Woodridge, Ill.), and is typically prepared by mixing the meringue powder with cold water (and optionally sugar/flavoring).

The priming material is applied to foodware surface in the region to be decorated/customized, e.g., using an applicator tool, brush or the like. Before applying the priming material, it may be desirable to shake, stir or otherwise mix the priming material to ensure substantial homogeneity, particularly if the priming material is supplied in a “pre-packaged” applicator or the like. Of note, the priming material may be supplied in predefined portion sizes to facilitate use thereof. For example, a first portion size may be scaled to facilitate priming of 6-8 plates, a second portion size may be scaled to facilitate priming 10-15 plates, etc. In this way, efficiencies in use are enhanced.

The disclosed system may include a “primer applicator” for use in applying the priming material to foodware surfaces. The primer applicator may be adapted to detachably engage with an applicator tip, e.g., an primer applicator brush. Thus, for example, an individual may secure (e.g., screw) a primer applicator brush to the distal end of a primer applicator unit that contains (or is adapted to receive) primer material. Once the primer applicator brush (or other applicator member) is in place, the individual may “invert” the primer applicator and lightly apply, e.g., brush, the priming material onto the foodware surface to be decorated/customized. Typically, the priming material should dry on the foodware surface in a relatively short time, e.g., after approximately 30 seconds.

Once the foodware surface is “primed,” the individual can move forward with desired customization/decoration of the foodware surface. Thus, for example, an applicator containing a desired color material and with a desired applicator tip shape may be used to apply desired decoration/customization to the primed surface of the foodware. The individual may apply the decorating/customizing material by lightly pressing down on a sponge tip associated with the applicator tip until the decorating/customizing material imprints itself onto the foodware (in the primed region). If the contents of the bottle seem at all clumpy or hard, the user can simply rinse the bottle under hot water and shake until decorating/customizing material is more pliable. Typically, it is desirable to allow the customizing/decorating material to dry, e.g., for about one minute, before dishing food onto the decorated/customized region, e.g., the decorated/customized surface of a plate, or introducing drinks into a decorated/customized cup/glass. Of note, it is generally desirable to position a customized/decorated region outside or way from the rims of glasses/cups so as to minimize the likelihood that the customization/decoration will be lost/dissolved during use.

The disclosed system/method may be used to create essentially any design or visual effect on the surface of foodware, e.g., to make everyday dishes/glasses more festive or appropriate for particular events/occasions. Once the foodware has been used, i.e., the event/meal is concluded, the customized/decorated foodware may be easily cleaned for reuse, e.g., by washing the foodware in the normal way (e.g., in a dishwasher). Sponge tips and primer brushes may also be cleaned for reuse, e.g., by removing the applicator tip/brush from the applicator unit, rinsing clean and then air drying. The primer and decorating material containers may be stored for future use, e.g., with caps screwed on tightly in any cabinet. Refrigeration is generally not necessary.

Thus, in an exemplary implementation of the present disclosure, a system for decoration or customization of foodware is provided that includes:
a. an applicator tool configured and dimensioned for use in applying a priming material to a region of a foodware surface, the applicator tool defining a hollow region and a discharge opening in flow communication with the hollow region;
b. a priming material that may be positioned within or introduced to the hollow region of the applicator tool, the priming material being sufficiently flowable for passage through the discharge opening of the applicator tool; and
c. at least one applicator tip (and preferably a plurality of applicator tips) configured and dimensioned for detachable engagement with the applicator tool, the at least one applicator tip including a predetermined tip geometry for use in applying a decorating or customizing material to the primed region of the foodware surface.

The disclosed system and method offers substantial advantages relative to prior art systems and techniques. For example, the disclosed decorations/customization are not permanent. In addition, unlike other products that are currently available, the disclosed decorating/customizing technique does not take long to apply and does not need to be baked in the oven to set. Still further, the customization/decoration is stable during use, but easily and efficiently removed (through conventional washing steps) after use. Thus, significant efficiencies are achieved according to the present disclosure.

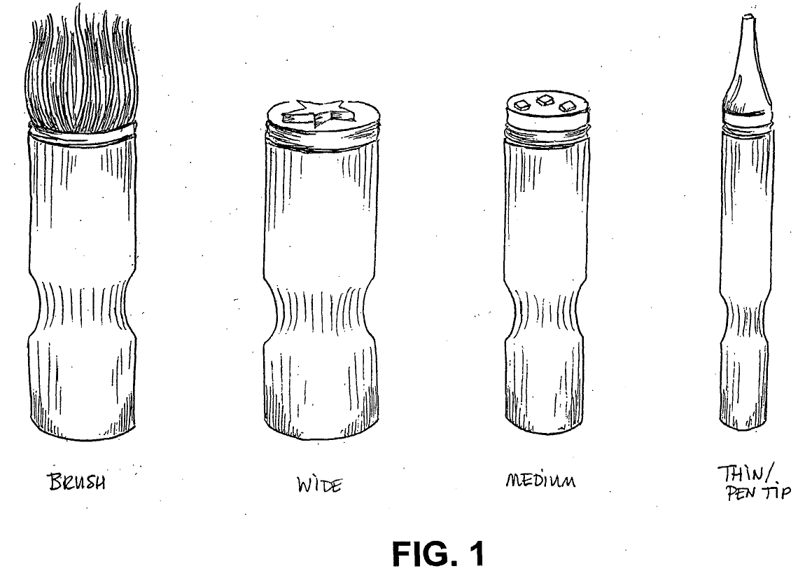

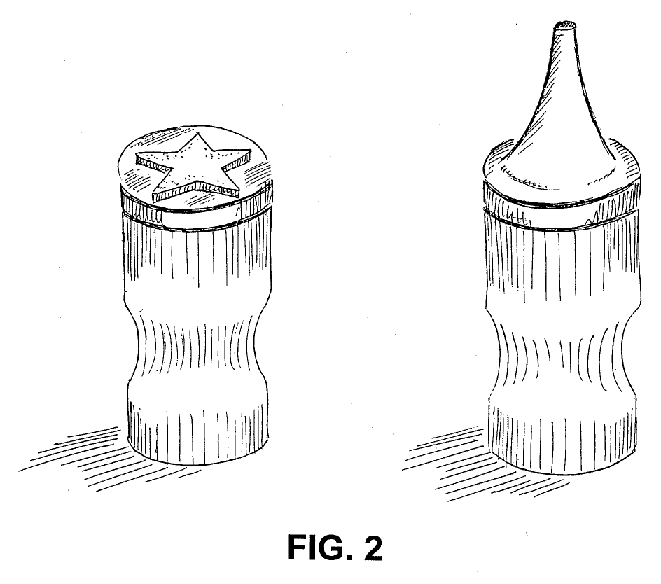

With reference to the appended figures, FIGS. 1 and 2 schematically depict exemplary applicator tools according to the present disclosure. As shown therein, the applicator tools may include an elongated, substantially cylindrical handle region that defines an internal region for receipt of applicator material, e.g., priming material and/or decorating/customizing material. Different applicator tips may be attached to the applicator tool (or an applicator tool may be fabricated with an integral applicator tip). As shown in FIG. 1, the applicator tip may take the form of a brush, a “wide” applicator tip (shown in the shape of a “star”), a “medium” applicator tip (shown in the shape of three spaced diamonds), or a “thin/pen tip” (for use in finer decorations/customizations). FIG. 2 provides further views of exemplary applicator tools with applicator tips joined thereto.

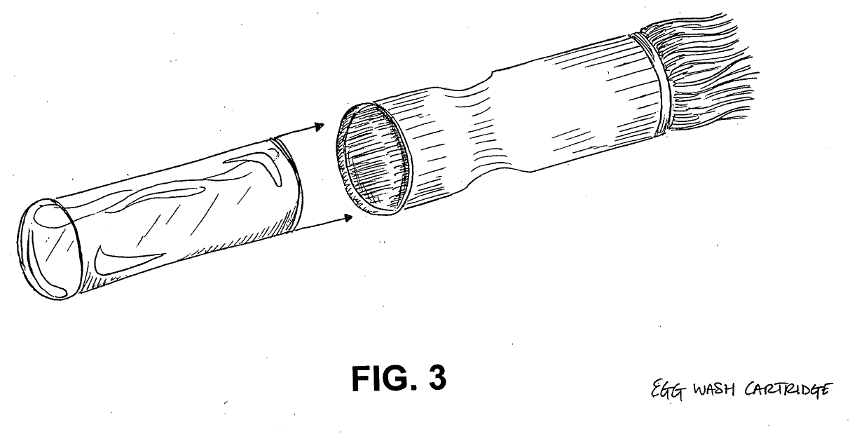

With reference to FIG. 3, an exemplary system for introduction of a priming material cartridge to the cylindrical handle of an applicator tool (with brush tip) is shown. The implementation of FIG. 3 reflects a technique whereby priming material may be prepackaged and supplied in a modular form. However, it is further contemplated that priming material (or decorating/customizing material) may be introduced directly to the hollow handle region of an applicator tool, e.g., from a mixing bowl, large dispensing container or the like. In the modular approach shown in FIG. 3, it is contemplated that the distal end of the priming material cartridge may feature a removal cap/lid that would be removed before introduction to the hollow handle region, or the overall assembly may include a mechanism for accessing the material within the cartridge, e.g., a “piercing” mechanism internal to the hollow handle.

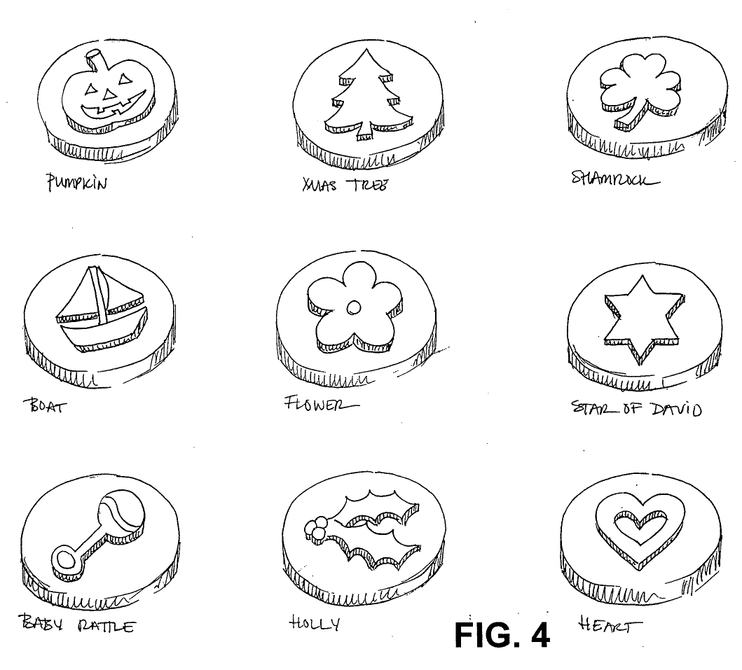

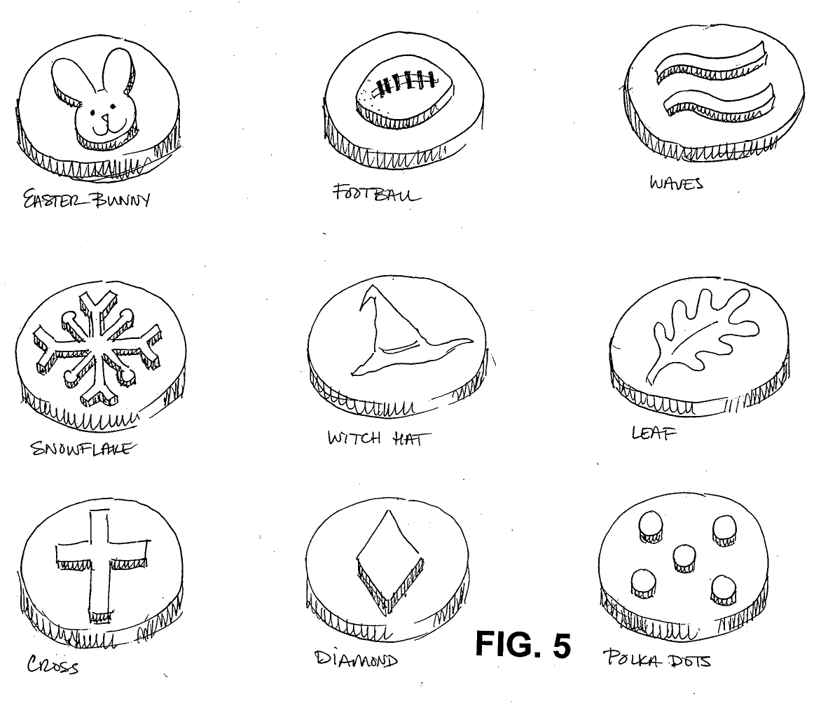

FIGS. 4 and 5 schematically depict various exemplary applicator tips for use in applying customization/decoration material to a primed foodware surface according to the present disclosure. Of note, the decorative shapes/designs may take essentially infinite form.

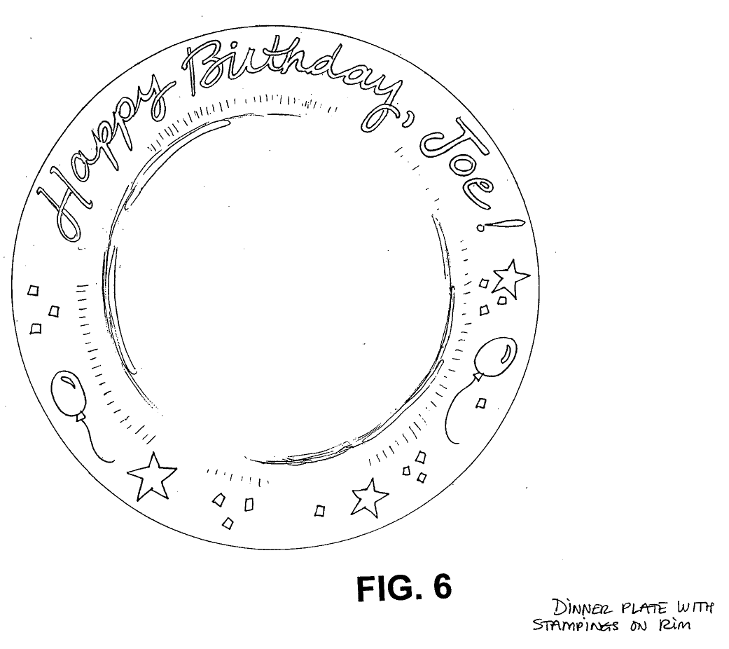

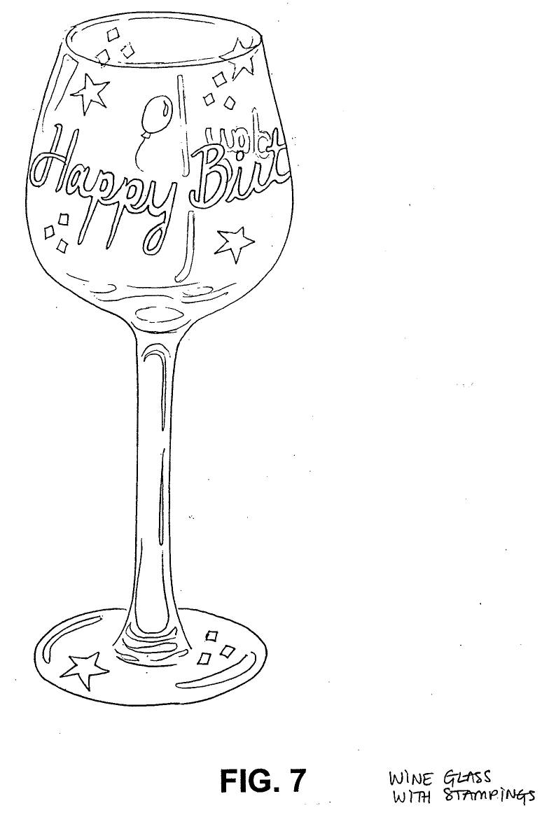

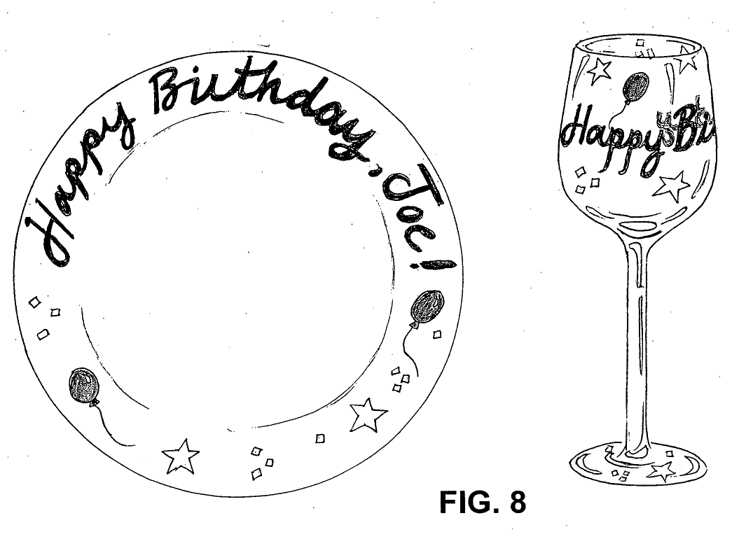

FIGS. 6-8 schematically depict exemplary foodware that have been decorated/customized according to the present disclosure. The disclosed systems and methods may be used on essentially any foodware surface, as described herein, and permit individuals to effectuate wide ranging and highly desirable customizations/decorations on an as-desired basis. The applied customizations/decorations are stable during use, e.g., with food or beverage (hot or cold) placed thereon or in contact therewith, at least in part based on the interaction with the priming material.

Of note, the systems and methods of the present disclosure may be supplied to users in kit form, such kit generally including, inter alia, at least one applicator tool, at least one applicator tip (preferably a plurality of applicator tips), priming material, and decorating/customizing material. The priming material may be supplied in predefined portion sizes to facilitate efficient use thereof.

Although the present disclosure has been described with reference to exemplary embodiments and implementations thereof, the present disclosure is not limited by or to such exemplary embodiments. Rather, the disclosed systems and methods are susceptible to variations, modifications and/or enhancements without departing from the spirit or scope hereof, as will be readily apparent to persons skilled in the art.

1. A method for decoration or customization of foodware, comprising:
a. applying a priming material to a region of a foodware surface;
b. applying a decorating or customizing material to the primed region of the foodware surface.

2. The method of claim 1, wherein the priming material is applied to the foodware surface using an applicator tool.

3. The method of claim 2, wherein the applicator tool includes a brush tip.

4. The method of claim 3, wherein the brush tip is detachably engaged to the applicator tool.

5. The method of claim 1, wherein the priming material is prepared from a material selected from the group consisting of egg whites and a meringue powder.

6. The method of claim 1, wherein the priming material is introduced to the applicator tool in a modular cartridge.

7. The method of claim 1, wherein the decorating or customizing material is applied to the primed region using an applicator tool.

8. The method of claim 7, wherein the applicator tool includes an applicator tip that facilitates implementation of a desired decorative or customization effect.

9. The method of claim 8, wherein the applicator tool is adapted to detachably engage with a plurality of applicator tips that facilitate different decorative or customization effects.

10. The method of claim 1, further comprising washing the priming material and the decorating or customizing materials from the foodware.

11. A system for decoration or customization of foodware, comprising:
a. an applicator tool configured and dimensioned for use in applying a priming material to a region of a foodware surface, said applicator tool defining a hollow region and a discharge opening in flow communication with the hollow region;
b. a priming material positioned within said hollow region of said applicator tool and sufficiently flowable for passage through said discharge opening; and
c. at least one applicator tip configured and dimensioned for detachable engagement with the applicator tool, the at least one applicator tip including a predetermined tip geometry for use in applying a decorating or customizing material to the primed region of the foodware surface.

12. The system of claim 11, wherein the applicator tool is adapted for detachable engagement with a brush tip.

13. The system of claim 11, wherein the priming material is prepared from a material selected from the group consisting of egg whites and a meringue powder.

14. The system of claim 11, wherein the priming material is introduced to the hollow region of the applicator tool in a modular cartridge.

15. The system of claim 11, wherein the applicator tool is adapted to detachably engage with a plurality of applicator tips that facilitate different decorative or customization effects.

16. A kit for decoration/customization of foodware, comprising:
a. at least one applicator tool;
b. at least one applicator tip;
c. priming material; and
d. decorating/customizing material
